(19) United States
(12) Patent Application Publication
(10) Pub. No.: US 2025/0272970 A1
(43) Pub. Date: Aug. 28, 2025

(54) SUPPLEMENTING SENSOR DATA FOR PROCESSING USING AI SYSTEMS AND APPLICATIONS

(71) Applicant: NVIDIA Corporation, Santa Clara, CA (US)

(72) Inventors: Swapnil Rathi, Pune (IN); Bhushan Rupde, Pune (IN); Kaustubh Purandare, San Jose, CA (US)

(21) Appl. No.: 18/587,028

(22) Filed: Feb. 26, 2024

(51) Int. Cl. G06V 10/96; G06V 20/50; H04N 19/46

(52) U.S. Cl. CPC G06V 10/96; G06V 20/50; H04N 19/46

(57) ABSTRACT

In various examples, processing sensor data using rankings for AI systems and applications is described herein. Systems and methods are disclosed that determine rankings for sensor data, where the rankings may then be used to process the sensor data. For instance, a device that generates sensor data using a sensor may determine rankings for various portions of the sensor data, such as by analyzing the sensor data and/or related sensor data to detect configured events. For example, if the sensor data includes image data, then the device may determine a respective ranking for different groups of frames that are associated with different events. A system(s) that then use the rankings when processing the sensor data using one or more processing tasks. For example, the system(s) may determine which processing tasks to use for processing different portions of the sensor data based at least on the rankings.

### BACKGROUND

Systems use processing pipelines to process sensor data received from devices, where the processing pipelines are configured to perform various processing tasks on the sensor data in order to generate outputs. For example, a system may use an image processing pipeline to process image data generated using a camera, where the image processing pipeline performs different types of image processing tasks such as inferencing, object detection, object tracking, and/or the like. Based at least on the configurations of the devices and/or the systems, these processing pipelines uniformly process an entirety of the sensor data (e.g., every frame of image data) to perform the processing tasks.

However, in some circumstances, not every portion of sensor data may be necessary to perform one or more of processing tasks in a processing pipeline. For example, if the image data in the example above represents a number of frames that do not depict objects and/or motion, then the image processing pipeline may not need to perform object detection or object tracking, and thus can skip (or reduce) the processing of at least some of these frames. As such, in some circumstances, these systems may utilize a greater amount of computing resources (e.g., computer processing unit resources, graphics processing unit resources, memory resources, etc.) for processing sensor data than is required to generate a desired output. Additionally, this over utilization of computing resources may increase when systems are processing sensor data in batches from multiple sensors and/or multiple devices.

### SUMMARY

Embodiments of the present disclosure relate to supplementing sensor data processing for processing in AI systems and applications. Systems and methods are disclosed that determine significance indicia (e.g., rankings) for various portions of sensor data, where the rankings may then be used to process the sensor data (e.g., using a processing pipeline). For instance, a device that generates sensor data using a sensor may determine a hierarchy for various portions of the sensor data, such as by analyzing the sensor data and/or related sensor data to detect configured events. For example, if the sensor data includes image data, then the device may determine a respective hierarchical ranking for different groups of frames that are associated with different events. A system(s) that then use the hierarchical rankings when processing the sensor data using one or more processing tasks. For example, the system(s) may determine which processing tasks to use for processing different portions of the sensor data based at least on the hierarchy.

In contrast to conventional systems, such as those described above, the current systems, in some embodiments, determine one or more hierarchies for various portions of sensor data, such as groups of frames of the sensor data, where the hierarchical rankings are then used during processing to select different processing tasks for the portions of the sensor data. This way, the current systems may not need to uniformly process all of the sensor data using the same processing tasks, which may save computing resources and/or increase the throughput of the processing by refraining from unnecessarily processing some portions of the sensor data using specific processing tasks. For example, instead of performing inferencing, object detection, and/or object tracking for every frame of image data, the current systems may refrain from processing at least a portion of the frames that do not depict objects and/or motion using these processing tasks. As will be described in more detail herein, these improvements of saving computing resources and/or increasing throughput may increase based at least on the number of devices and/or the amount of sensor data for which processing is being performed.

### BRIEF DESCRIPTION OF THE DRAWINGS

The present systems and methods for supplementing sensor data for processing in AI systems and applications are described in detail below with reference to the attached drawing figures, wherein:

FIG. 1 illustrates an example of a process for determining rankings for sensor data, where the rankings are then used to process the sensor data, in accordance with some embodiments of the present disclosure;

FIG. 2 illustrates an example of configuration data that may be used for ranking sensor data, in accordance with some embodiments of the present disclosure;

FIG. 3 illustrates an example of processing image data to detect events, in accordance with some embodiments of the present disclosure;

FIG. 4 illustrates an example of ranking images based at least on detected events, in accordance with some embodiments of the present disclosure;

FIG. 5 illustrates an example of processing frames using different processing components, where the ranking is based at least on rankings associated with the frames, in accordance with some embodiments of the present disclosure;

FIG. 6 is a flow diagram showing a method for ranking sensor data, in accordance with some embodiments of the present disclosure;

FIG. 7 is a flow diagram showing a method for using one or more rankings associated with sensor data in order to process the sensor data, in accordance with some embodiments of the present disclosure;

FIG. 8 is a block diagram of an example content streaming system suitable for use in implementing some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

Systems and methods are disclosed related to supplementing sensor data for processing in AI systems and applications. For instance, a device may generate sensor data using one or more sensors. As described herein, the sensor data may include, but is not limited to, image data generated using one or more image sensors (e.g., one or more cameras), audio data generated using one or more microphones, LiDAR data generated using one or more LiDAR sensors, RADAR data generated using one or more RADAR sensors, motion data generated using one or more motion sensors (e.g., one or more passive infrared sensors, etc.), and/or any other type of sensor data generated using any other type of sensor. The device may then send at least a portion of the sensor data to one or more systems for processing. For example, the device may send the image data to the system(s) that is configured to process the image data using one or more image processing pipelines.

In some examples, the device may rank at least a portion of the sensor data before sending the sensor data to one or more computing device(s) (e.g., the system(s)). For instance, the device may determine a respective ranking for different groups of sensor representations (e.g., groups of frames), where a group of sensor representations may include one sensor representation, five sensor representations, ten sensor representations, thirty sensor representations, and/or any other number of sensor representations. For a first example, when determining rankings for frames of image data, the device may determine a respective ranking for each frame represented by the image data. For a second example, and again when determining rankings for frames of image data, the device may determine a respective ranking for each group of frames represented by the image data, such as based on a ranking associated with one of the frames (e.g., the first frame) included in the group of frames.

To determine the rankings, the device may receive, obtain, generate, and/or be configured with data (referred to, in some examples, as “configuration data”) representing information for ranking the sensor representations. For instance, the configuration data may represent at least a first ranking associated with a first event, a second ranking associated with a second event, a third ranking associated with a third event, and/or so forth. For example, when ranking frames, the configuration data may indicate or include rankings associated with slow motion being detected, fast motion being detected, an object being detected, low light being detected, custom weightage, no motion being detected, and/or any other ranking types associated with other event types. The device may then use this configuration data and/or one or more processing techniques to rank sensor data.

For instance, in some examples, the device may process at least a portion of the sensor data for which the device is ranking to detect one or more of the events associated with the configuration data. In some examples, when processing the sensor data, the device may use one or more machine learning models, one or more neural networks, one or more algorithms, one or more modules, one or more software applications, one or more hardware components, and/or any other type of processing component that is configured to process sensor data to perform a task. Additionally, as will be described in more detail herein, the processing component(s) used by the device may require fewer computing resources as compared to one or more processing components later used by the system(s) that then uses the rankings to process the sensor data. For example, if the device is processing the sensor data using one or more machine learning models associated with object and/or motion detection, then the machine learning model(s) may include fewer layers (e.g., include a “lightweight” machine learning model) as compared to one or more machine learning models later used by the system(s) to perform object and/or motion detection.

For an example of processing sensor data, and if the sensor data again includes image data, the device may process at least a portion of the image data to determine whether a frame is associated with one or more of the events represented by the configuration data. For instance, the device may determine whether the frame depicts an object, depicts low light, is associated with motion, and/or is associated with any other type of event. Based at least on determining that the frame is associated with an event, such as a detected object, the device may then rank the frame using the ranking that is associated with the event, such as the third ranking in the example above. In some examples, the device may perform similar processes to rank each of the other frames of the image data. Additionally, or alternatively, in some examples, the device may then use that ranking for a group of frames, such as a number of next frames (e.g., one next frame, five next frames, ten next frames, thirty next frames, etc.) of the image data. The device may then continue to perform similar processes to rank additional groups of frames of the image data.

Additionally to, or alternatively from, processing the sensor data for which the device is ranking, in some examples, the device may process additional sensor data to detect one or more of the events associated with the configuration data. For example, and again if the sensor data being ranked includes image data, the device may process motion data to detect an event, such as a presence of an object being detected or an object not being detected (e.g., an absence of an object). The device may then associate at least a portion of the image data with the detected event. For example, the device may associate one or more frames of the image data, which were generated at an approximately same time as the motion data, with the event. The device may then perform one or more of the processes described herein to rank the frame(s) of the image data based at least on the associated event. Additionally, in some examples, the device may perform similar processes for other types of additional sensor data that may be used to detect one or more of the events, such as audio data, LiDAR data, RADAR data, and/or the like.

The device may then generate data (referred to, in some examples, as “ranking data”) representing the rankings for the sensor data and send the ranking data along with the sensor data to the system(s) for processing. As described herein, the device may use any technique to send the ranking data along with the sensor data to the system(s). For example, and again if the sensor data includes image data, the device may embed the rankings into messages (e.g., supplemental enhanced information messages, etc.) associated with the image data and/or embed the rankings using dedicates fields of the image data. The device may also encode the image data, either before and/or after the embedding, to the generated encoded image data. After performing this processing, the device may send the encoded image data along with the embedded rankings to the system(s) for processing.

The system(s) may then use the rankings when processing the sensor data using one or more processing tasks, where the processing task(s) may be associated with a processing pipeline. For instance, the system(s) may determine which processing task(s) to use when processing portions of the sensor data, which processing task(s) to refrain from using when processing portions of the sensor data, additional processing task(s) (e.g., outside of the processing pipeline) to use to process the portions of the sensor data, and/or the like using the rankings. For a first example, and again if the sensor data includes image data, if a first ranking associated with one or more first frames indicates that the first frame(s) is associated with an object being detected, then the system(s) may process the first frame(s) using a processing task(s) associated with inferencing, object detection, and/or object tracking. However, if a second ranking associated with one or more second frames indicates that the second frame(s) is not associated with an object being detected, then the system(s) may refrain from processing the second frame(s) using the same processing tasks(s).

For a second example, and again if the sensor data includes image data, if a first ranking associated with one or more first frames indicates that the first frame(s) is associated with motion from a single object, then the system(s) may process the first frame(s) using a first processing task(s) associated with inferencing, object detection, and/or object tracking. However, if a second ranking associated with one or more second frames indicates that the second frame(s) is associated with motion from multiple objects, then the system(s) may process the second frame(s) using a second processing tasks(s) that is also associated with inferencing, object detection, and/or object tracking. However, in this second example, the second processing task(s) may include higher quality machine learning models, neural networks, algorithms, and/or the like as compared to the first processing task(s) such that the second processing task(s) is better able to process sensor data that is associated with multiple objects.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

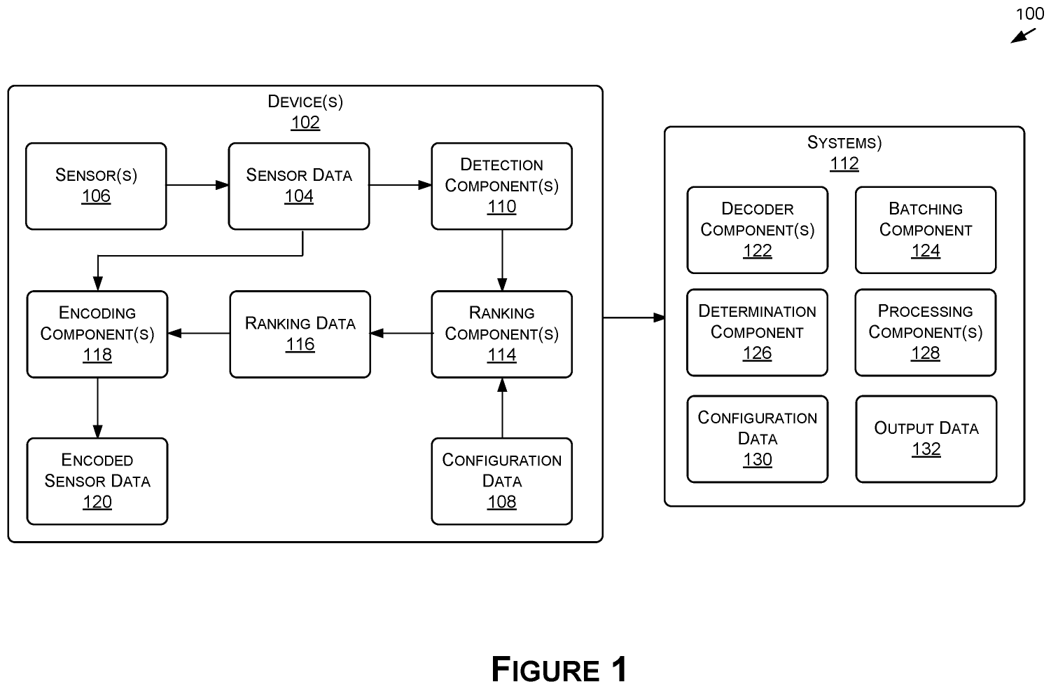

With reference to FIG. 1, FIG. 1 illustrates an example of a process 100 for determining rankings for sensor data, where the rankings are then used to process the sensor data, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include at least one device 102 generating sensor data 104 using one or more sensors 106. As described herein, the sensor data 104 may include, but is not limited to, image data generated using one or more image sensors (e.g., one or more cameras), audio data generated using one or more microphones, LiDAR data generated using one or more LiDAR sensors, RADAR data generated using one or more RADAR sensors, motion data generated using one or more motion sensors (e.g., one or more passive infrared sensors, etc.), and/or any other type of sensor data generated using any other type of sensor. In some examples, the sensor data 104 may represent sensor representations. For example, and for image data, the image data may represent frames. Additionally, in some examples, the sensor data 104 may represent other types of information, such as timestamps indicating when portions of the sensor data 104 (e.g., sensor representations) are generated using the sensor(s) 106. For example, and again for the image data, the image data may represent a respective timestamp when one or more frames of the image data are generated using the image sensor(s).

As described herein, the device 102 may then perform one or more techniques in order to rank one or more portions of the sensor data 104. For instance, the device 102 may use configuration data 108 representing information for ranking the sensor representations of the sensor data 104. In some examples, the configuration data 108 may represent at least a first ranking associated with a first event, a second ranking associated with a second event, a third ranking associated with a third event, and/or so forth. For example, if the device 102 is used to process data corresponding to ranking frames of image data, the configuration data 108 may indicate or include rankings associated with slow motion being detected, fast motion being detected, an object being detected, low light being detected, custom weightage, no motion being detected, and/or any other ranking types associated with other event types, and/or the like. In some examples, the device 102 may be preconfigured with the configuration data 108. Additionally, or alternatively, in some examples, one or more users may be able to generate and/or update the configuration data 108 to include additional and/or alternative events for ranking sensor data 104. For example, the user(s) may be able to customize the configuration data 108 based on processing tasks that may be used when processing on the sensor data 104.

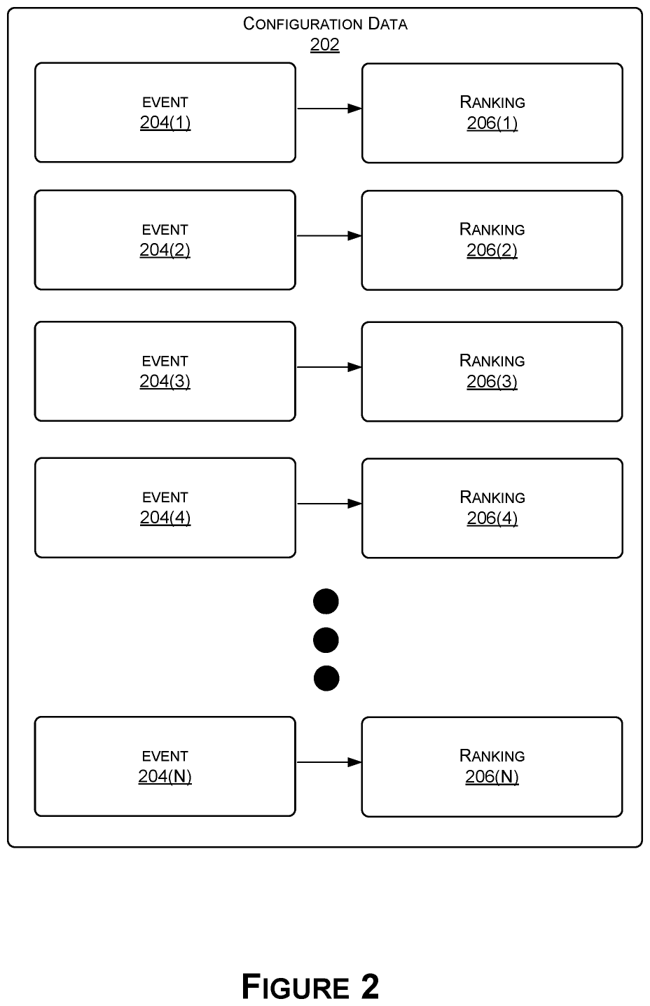

For instance, FIG. 2 illustrates an example of configuration data 202 (which may represent, and/or be similar to, the configuration data 108) that may be used for ranking sensor data (e.g., sensor data 104), in accordance with some embodiments of the present disclosure. As shown, the configuration data 202 may associate various events 204(1)-(N) (also referred to singularly as “event 204” or in plural as “events 204”) with different rankings 206(1)-(N) (also referred to singularly as “ranking 206” or in plural as “rankings 206”). For a first example, if the configuration data 202 is associated with image data, then the events 204 may include an object is detected, a type of object that is detected, motion is detected, slow motion is detected, fast motion is detected, a close object is detected, a distant object is detected, low light is detected, and/or any other events associated with image detection. For a second example, if the configuration data 202 is associated with audio data, then the events 204 may include sound is detected, speech is detected, specific speech (e.g., specific words) is detected, and/or any other event associated with audio data.

The rankings 206 may include numerical rankings, alphabetical rankings, alphanumeric rankings, characters, syllables, symbols, and/or any other type ranking. For a first example, the first ranking 206(1) may include a first number (e.g., 1), the second ranking 206(2) may include a second number (e.g., 2), the third ranking 206(3) may include a third number (e.g., 3), and/or so forth. For a second example, the first ranking 206(1) may include a first letter (e.g., A), the second ranking 206(2) may include a second letter (e.g., B), the third ranking 206(3) may include a third letter (e.g., C), and/or so forth. While these are just a few examples of rankings that may be used for sensor data, in other examples, any other type of ranking may be used for the sensor data.

While the example of FIG. 2 illustrates that each event 204 is associated with a single ranking 206, in other examples, one or more of the events 204 may be associated with multiple rankings. For example, the first event 204(1) may be associated with the first ranking 206(1) along with at least one other ranking. Additionally, in some examples, more than one event 204 may associated with the same ranking 206. For example, the first ranking 206(1) associated with the first event 204(1) may be the same as the second ranking 206(2) associated with the second event 204(2).

Referring back to the example of FIG. 1, and with regard to the ranking, the process 100 may include the device 102 using one or more detection components 110 processing at least a portion of the sensor data 104 in order to detect events. As described herein, in some examples, the detection component(s) 110 may process the same sensor data 104 for which the device 102 is processing or determining a ranking when detecting the events. In some examples, when processing the sensor data 104 that is being ranked, the detection component(s) 110 may use one or more machine learning models, one or more neural networks, one or more algorithms, one or more modules, and/or any other type of processing component. Additionally, as will be described in more detail herein, the processing component(s) used by the detection component(s) 110 may require less computing resources as compared to one or more processing components later used by one or more systems 112 that then use the rankings to process the sensor data 104.

For a first example of processing sensor data 104, and if the sensor data 104 includes image data, the detection component(s) 110 may process at least a portion of the image data to determine whether a frame is associated with one or more events. For instance, the detection component(s) 110 may determine whether the frame depicts an object, depicts a type of object, does not depict an object, depicts low light, is associated with motion, is associated with a specific pace of motion (e.g., slow motion, fast motion, etc.), and/or so forth. For a second example of processing sensor data 104, and if the sensor data 104 includes audio data, the detection component(s) 110 may process at least a portion of the audio data to determine whether an audio frame is associated with one or more events. For instance, the detection component(s) 110 may determine whether the audio frame is associated with sound, is not associated with sound, associated with speech, is associated with one or more words of speech, is associated with speech from a specific user, is not associated with speech, and/or so forth.

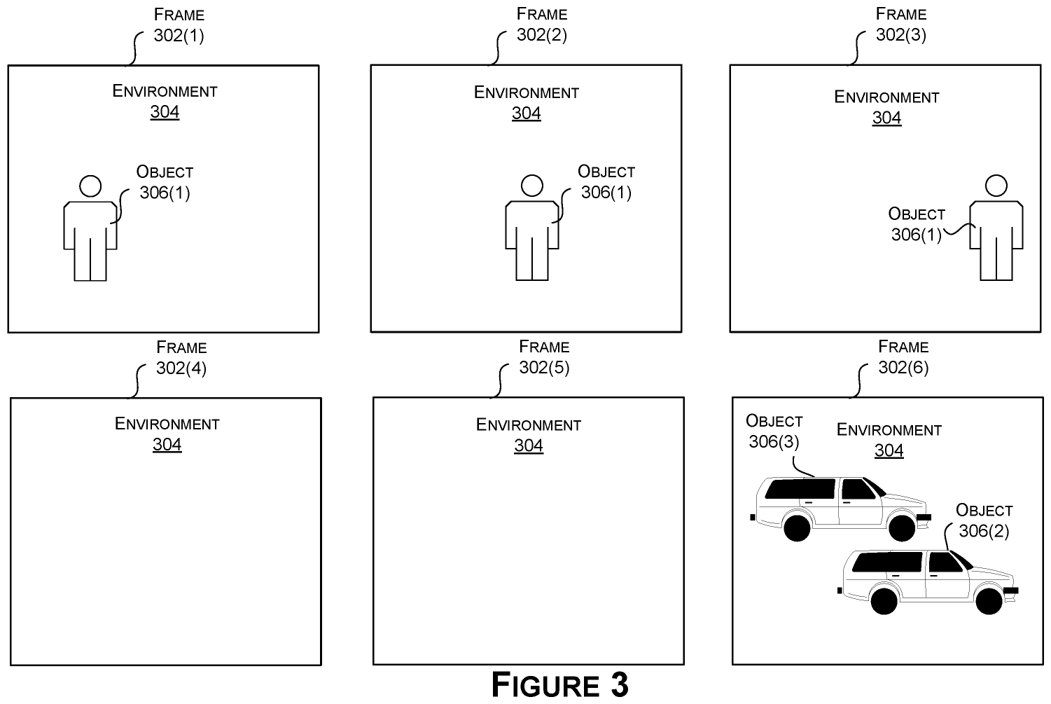

For instance, FIG. 3 illustrates an example of processing image data to detect events, in accordance with some embodiments of the present disclosure. In the example of FIG. 3, the detection component(s) 110 may be processing image data representing at least frames 302(1)-(6) (also referred to singularly as “frame 302” or in plural as “frames 302”). As shown, the frames 302 may depict at least an environment 304, where various objects may move within the environment 302. As such, based at least on the processing, the detection component(s) 110 may determine that the first frame 302(1) is associated with a detected object 306(1) and/or motion, the second frame 302(2) is associated with the detected object 306(1) and/or motion, the third frame 302(3) is associated with the detected object 306(1) and/or motion, the fourth frame 302(4) is associated with no object detection and/or no motion, the fifth frame 302(5) is associated with no object detection and/or no motion, and the sixth frame 302(6) is associated with detected objects 306(2)-(3) and/or motion.

In some examples, the detection component(s) 110 may determine additional information associated with one or more of the frames 302 based at least on the processing. For example, the detection component(s) 110 may determine a first type (e.g., person) associated with the object 306(1), a second type (e.g., vehicle) associated with the objects 306(2)-(3), bounding shapes (e.g., bounding boxes, bounding circles, bounding hexagons, etc.) associated with the objects 306(1)-(3) as depicted in the images 302, directions of travel associated with the objects 306(1)-(3), velocities associated with the objects 306(1)-(3), amounts of light associated with the frames 302 and/or the environment 304, and/or any other information.

Referring back to the example of FIG. 1, in addition to, or alternatively from, the detection component(s) 110 detecting events using the sensor data 104 that is being ranked, in some examples, the detection component(s) 110 may detect events using additional sensor data 104 for which the device 102 may not be ranking. For instance, the detection component(s) 110 may process the additional sensor data 104 in order to detect objects, detect motion of objects, detect no objects, detect sound, detect speech, detect an amount of light, detect a temperature, and/or detect any other type of event. For a first example, the detection component(s) 110 may process motion data, LiDAR data, and/or RADAR data in order to detect objects and/or motion of objects. For a second example, the detection component(s) 110 may process audio data in order to detect sound, speech, and/or any other noise events. While these are just a few examples of the detection component(s) 110 using additional sensor data 104 to detect events, in other examples, the detection component(s) 110 may detect any other type of event using the additional sensor data 104.

In some examples, the detection component(s) 110 may be configured to process an entirety of the sensor data 104 to detect events. For example, if the sensor data 104 includes image data, the detection component(s) 110 may be configured to process all of the frames of the image data in order to detect respective events associated with each of the frames. In some examples, the detection component(s) 110 may be configured to process only a portion of the sensor data 104 to detect events. For example, and again if the sensor data 104 includes image data, the detection component(s) 110 may be configured to process every other frame, or frames at any other interval or periodicity, and/or the like to detect respective events associated with the processed frames. In such examples, the detection component(s) 110 may only process a portion of the sensor data 104 in order to conserve computing resources.

The process 100 may then include the device 102 using a ranking component 114 to rank at least a portion of the sensor data 104 based at least on the events detected by the detection component(s) 110. As described herein, in some examples, the ranking component 114 may be configured to determine a respective ranking for each sensor representation (e.g., each frame) of the sensor data 104. However, in other examples, the ranking component 114 may be configured to determine a respective ranking for groups of sensor representations (e.g., groups of frames) of the sensor data 104. For example, if the ranking component 114 determines a ranking associated with a sensor representation associated with the group of sensor representations, then the ranking component 114 may associate with entire group of sensor representations with the ranking. In such an example, the ranking component 114 may determine the ranking for the first sensor representation, an intermediate sensor representation, the last sensor representation, and/or any other sensor representation included in the group of sensor representations.

To determine a ranking for a sensor representation (and/or a group of sensor representations), the ranking component 114 may use the output from the detection component(s) 110 to determine an event associated with the sensor representation. The ranking component 114 may then use the event, along with the configuration data 108, to determine the ranking for the sensor representation. For a first example, if a first event corresponding to a first sensor representation is associated with a first ranking, then the ranking component 114 may associate the first sensor representation with the first ranking. Additionally, if a second event corresponding to a second sensor representation is associated with a second ranking, then the ranking component 114 may associate the second sensor representation with the second ranking. For a second example, if a first event corresponding to a first group of sensor representations is associated with a first ranking, then the ranking component 114 may associate the sensor representations included in the first group of sensor representations with the first ranking. Additionally, if a second event corresponding to a second group of sensor representations is associated with a second ranking, then the ranking component 114 may associate the sensor representations included in the second group of sensor representations with the second ranking.

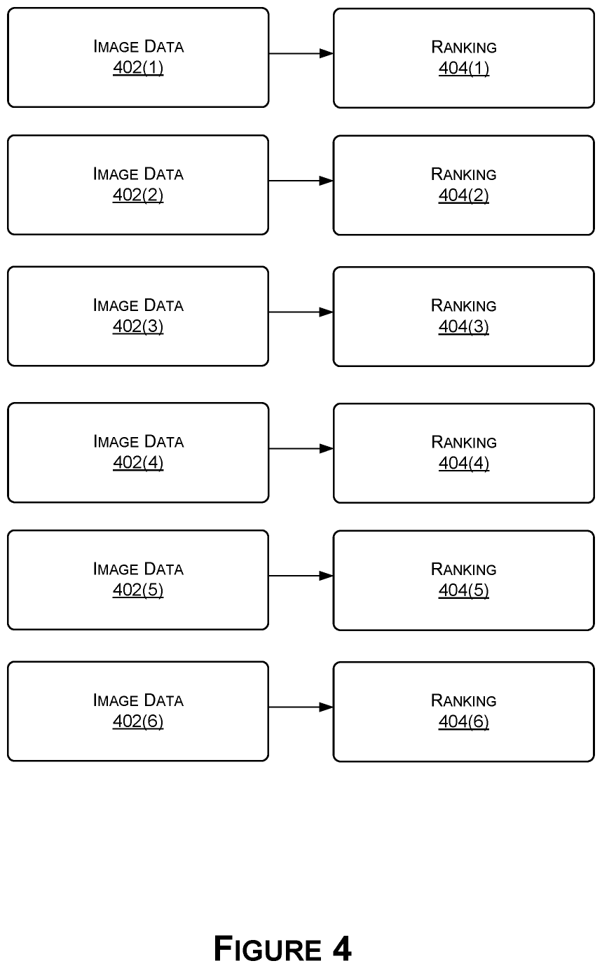

For instance, FIG. 4 illustrates an example of ranking the frames 302 based at least on detected events, in accordance with some embodiments of the present disclosure. As shown, the ranking component 114 may associate first image data 402(1) representing the first frame 302(1) with a first ranking 404(1), second image data 402(2) representing the second frame 302(2) with a second ranking 404(2), third image data 402(3) representing the third frame 302(3) with a third ranking 404(3), fourth image data 402(4) representing the fourth frame 302(4) with a fourth ranking 404(4), fifth image data 402(5) representing the fifth frame 302(5) with a fifth ranking 404(5), and sixth image data 402(6) representing the sixth frame 302(6) with a sixth ranking 404(6). In some examples, one or more of the ranking 404(1)-(6) (which may also be referred to singularly as “ranking 404” or in plural as “rankings 404”) may be similar to one another.

For a first example, the rankings 404(1)-(3) and 404(6) may be similar to one another based at least on the events associated with the frames 302(1)-(3) and 302(6) indicating a detected object 306(1)-(3) and/or motion of a detected object 306(1)-(3). For a second example, the rankings 404(1)-(3) may be similar to one another based at least on the events associated with the frames 302(1)-(3) indicating a same type of detected object 306(1). However, the sixth ranking 404(6) may be different than the rankings 404(1)-(3) based at least on the event associated with the sixth frame 302(6) indicating a second type of detected objects 306(2)-(3). For a third example, the rankings 404(4)-(5) may be similar to one another based at least on the events associated with the frames 302(4)-(5) indicating that no objects and/or motion were detected. While these are just a few examples of rankings 404 that may be similar to one another, in other examples, other rankings 404 may be similar to one another based at least on the events associated with the frames 302.

Referring back to the example of FIG. 1, in some examples, the ranking component 114 may perform additional processing when ranking the sensor data 104. For instance, if the ranking component 114 is ranking first sensor data 104 generated using a first sensor 106 based at least on events detected using second sensor data 104 generated using a second sensor 106, then the ranking component 114 may initially determine which events detected using the second sensor data 104 to associate with portions of the first sensor data 104. For example, and for an event, the ranking component 114 may use second timestamps associated with the second sensor data 104 to determine a time that the event was detected. The ranking component 114 may then use first timestamps associated with the first sensor data 104 to determine a portion of the first sensor data 104 that is associated with the time. For instance, the ranking component 114 may determine that the portion of the first sensor data 104 was generated at the time and/or approximate to the time. The ranking component 114 may then associate that portion of the first sensor data 104 with the event.

In other words, the ranking component 114 may use the first timestamps and/or the second timestamps to align the first sensor data 104 with the second sensor data 104. The ranking component 114 may then use the alignment to associate the events detected using the second sensor data 104 with the first sensor data 104. In some examples, an event detected using the second sensor data 104 may be associated with a single sensor representation of the first sensor data 104. In some examples, an event detected using the second sensor data 104 may be associated with multiple sensor representations of the first sensor data 104.

As further shown by the example of FIG. 1, the process 100 may include the device 102 using the ranking component 114 and/or an encoding component 118 to associate the rankings, which are represented by ranking data 116, with the sensor data 104. In some examples, to associate a ranking with a portion of the sensor data 104, the ranking component 114 and/or the encoding component 118 may embed the ranking as a message (e.g., a SEI message) and/or as part of a dedicated field associated with the portion of the sensor data 104 in a bitstream. For example, if the sensor data 104 includes image data, then the ranking component 114 and/or the encoding component 118 may embed the ranking as a message and/or as part of a dedicated field associated with a frame of the image data in a bitstream. In some examples, such as when the ranking component 114 and/or the encoding component 118 is embedding the ranking to a group of sensor representations, then the ranking component 114 and/or the encoding component 118 may perform similar processes to embed the ranking into one or more (e.g., each) of the sensor representations included in the group of sensor representations.

The process 100 may also include the encoding component 118 encoding the sensor data 104 in order to generate encoded sensor data 120. In some examples, the encoding component 118 may encode the sensor data 104 after embedding the ranking while, in other examples, the encoding component 118 may encode the sensor data 104 before embedding the ranking. In either example, after performing the encoding, the encoded sensor data 120 may represent the sensor data 104 encoded with the embedded ranking. While the example of FIG. 1 describes embedding the ranking into the sensor data 104 and/or the encoded sensor data 120, in other examples, the device 102 may keep the ranking data 116 separate from the sensor data 104 and/or the encoded sensor data 104.

The process 100 may then include the device(s) 102 sending the encoded sensor data 120, the ranking data 116, and/or the sensor data 104 to the system(s) 112 for processing. In some examples, such as when the system(s) 112 processes data from multiple devices 102, one or more (e.g., each) of the devices 102 may send the encoded sensor data 120, the ranking data 116, and/or the sensor data 104 to the system(s) 112. As described herein, the system(s) 112 may be configured to process the sensor data 104 using one or more processing tasks, such as processing tasks that are associated with a processing pipeline. For a first example, if the system(s) 112 is processing image data using an image processing pipeline, then the system(s) 112 may process the image data to perform one or more inferencing tasks, one or more object detection tasks, one or more object tracking tasks, one or more lighting estimation or simulation tasks, and/or any other type of processing task that may be performed on image data. For a second example, if the system(s) 112 is processing audio data using an audio processing pipeline, then the system(s) 112 may process the audio data to perform one or more speech recognition tasks, one or more voice recognition tasks, one or more natural language understanding tasks, one or more speaker recognition tasks, and/or any other type of processing task that may be performed on audio data.

As shown, the process 100 may include the system(s) 112 using one or more decoder components 122 to decode the encoded sensor data 120 in order to again generate (e.g., obtain, retrieve, etc.) the sensor data 104. For instance, the system(s) 112 may use a respective decoder component 122 to decode the encoded sensor data 120 from one or more (e.g., each) of the device(s) 102. The process 100 may then include the system(s) 112 using a batching component 124 to perform batch processing associated with the sensor data 104. For instance, the batching component 124 may perform batching by at least collecting and/or combining the sensor data 104 from the different devices 102. In some examples, the batching component 124 may further perform the batch processing by aligning the sensor data 104 from the devices 102 with one another, such as based on timestamps associated with the sensor data 104. By performing batch processing according to such processes, the system(s) 112 may be able to process the sensor data 104 for the devices 102 together using the processing task(s) (e.g., using the processing pipeline).

The process 100 may include the system(s) 112 using a determination component 126 that is configured to determine how to process the sensor data 104. As described herein, in some examples, the determination component 126 may use the rankings associated with the sensor data 104 to determine how to process portions of the sensor data 104 using one or more processing components 128, where the processing component(s) 128 is associated with performing the one or more processing tasks. For example, and for a portion of the sensor data 104 (e.g., one or more frames of the sensor data 104), the determination component 126 may determine to process the portion of the sensor data 104 using one or more of the processing component(s) 128 based at least on the ranking associated with the portion of the sensor data 104 and/or determine to refrain from processing the portion of the sensor data 104 using one or more of the processing component(s) 128 based at least on the ranking.

In some examples, the determination component 126 may additionally using configuration data 130 to determine how to process the portions of the sensor data 104 using the processing component(s) 128. For instance, the configuration data 130 may associate respective rankings with one or more processing component(s) 128 for processing the sensor data 104. For example, the configuration data 130 may associate a first ranking with one or more first processing components 128, a second ranking with one or more second processing components 128, a third ranking with one or more third processing components 128, and/or so forth.

For a first example, if the sensor data 104 includes image data, then the determination component 126 may determine to process one or more first frames of the image data to perform one or more inferencing operations, one or more object detection operations, and/or one or more object tracking operations based at least on the first frame(s) being associated with one or more first rankings. For instance, the first ranking(s) may be associated with one or more first events such as an object being detected, motion being detected, and/or any other event that is associated with the first frame(s) depicting an object. In some examples, the configuration data 130 may associate the first ranking(s) with inferencing, object detection, and/or object tracking. Additionally, the determination component 126 may determine to refrain from processing one or more second frames of the image data—and refrain from performing one or more of the inferencing operations, one or more of the object detection operations, and/or one or more of the object tracking operations based at least on the second frame(s) being associated with one or more second rankings. For instance, the second ranking(s) may be associated with one or more second events that indicate no object and/or no motion was detected. In some examples, the configuration data 130 may associate the second ranking(s) with no processing tasks and/or processing tasks other than inferencing, object detection, and/or object tracking.

For a second example, and again if the sensor data 104 includes image data, then the determination component 126 may determine to process one or more first frames of the image data using a first tracking component based at least on the first frame(s) being associated with one or more first rankings. For instance, the first ranking(s) may be associated with one or more first events such as detection of only a single object. In some examples, the configuration data 130 may associate the first ranking(s) with the first tracking component. Additionally, the determination component 126 may determine to process one or more second frames of the image data using a second tracking component based at least on the second frame(s) being associated with one or more second rankings. For instance, the second ranking(s) may be associated with one or more second events such as a detection of multiple objects. In some examples, the configuration data 130 may associate the second ranking(s) with the second tracking component. Additionally, in such an example, the second tracking component may use higher quality object trackers as compared to the first tracking component such that the second tracking component is better at tracking multiple objects. However, the second tracking component may also use a greater amount of computing resources as compared to the first tracking component.

For a third example, if the sensor data 104 includes audio data, then the determination component 126 may determine to process one or more first audio frames of the audio data to perform sound recognition and/or speech recognition based at least on the first audio frame(s) being associated with one or more first rankings. For instance, the first ranking(s) may be associated with one or more first events such as the first audio frame(s) being associated with detected sound. In some examples, the configuration data 130 may associate the first ranking(s) with the sound recognition and/or the speech recognition. Additionally, the determination component 126 may determine to refrain from processing one or more second audio frames of the audio data to perform one or more of the sound recognition operations and/or one or more of the speech recognition operations based at least on the second audio frame(s) being associated with one or more second rankings. For instance, the second ranking(s) may be associated with one or more second events that indicate no sound was detected. In some examples, the configuration data 130 may associate the second ranking(s) with no processing tasks and/or processing tasks other than sound recognition and/or speech recognition.

The process 100 may then include the system(s) 112 processing portions of the sensor data 104 based at least on the output from the determination component 126. For instance, and for a portion of the sensor data 104, the system(s) 112 may process the portion of the sensor data 104 using one or more of the processing component(s) 128 for which the determination component 126 selected for processing. As described herein, a processing component 128 may include one or more machine learning models, one or more neural networks, one or more algorithms, one or more modules, one or more software applications, one or more hardware components, and/or any other type of computing resources that is configured to process sensor data 104 to perform a task.

For a first example, if a ranking indicates that one or more frames of image data are associated with a detected object, and the determination component 126 then determines that the frame(s) should be processed using inference, object detection, and/or object tracking, then the system(s) 112 may process the frame(s) using a first processing component 128 that performs inferencing, a second processing component 128 that performs object detection, and/or a third processing component 128 that performs object tracking. For a second example, if a ranking indicates that one or more frames of image data are not associated with a detected object, and the determination component 126 then determines that the frame(s) should not be processed using inference, object detection, and/or object tracking, then the system(s) 112 may refrain from processing the frame(s) using a first processing component 128 that performs inferencing, a second processing component 128 that performs object detection, and/or a third processing component 128 that performs object tracking.

In some examples, the system(s) 112 may refrain from processing a portion of sensor data 104 using a processing component 128 by not applying the portion of the sensor data 104 to the processing component 128. In some examples, the system(s) 112 may refrain from processing a portion of the sensor data 104 using a processing component 128 by still applying the portion of the sensor data 104 to the processing component 128, but causing the processing component 128 to refrain from performing any processing (e.g., the portion of the sensor data 104 just passes through the processing component 128). In such examples, rather than processing the portion of the sensor data 104, the processing component 128 may generate a set output, such as an output that is similar to a previous portion of the sensor data 104 that was processed by the processing component 128. In other words, the processing component 128 may continue to output the same output until the processing component 128 is caused to again process a new portion of the sensor data 104.

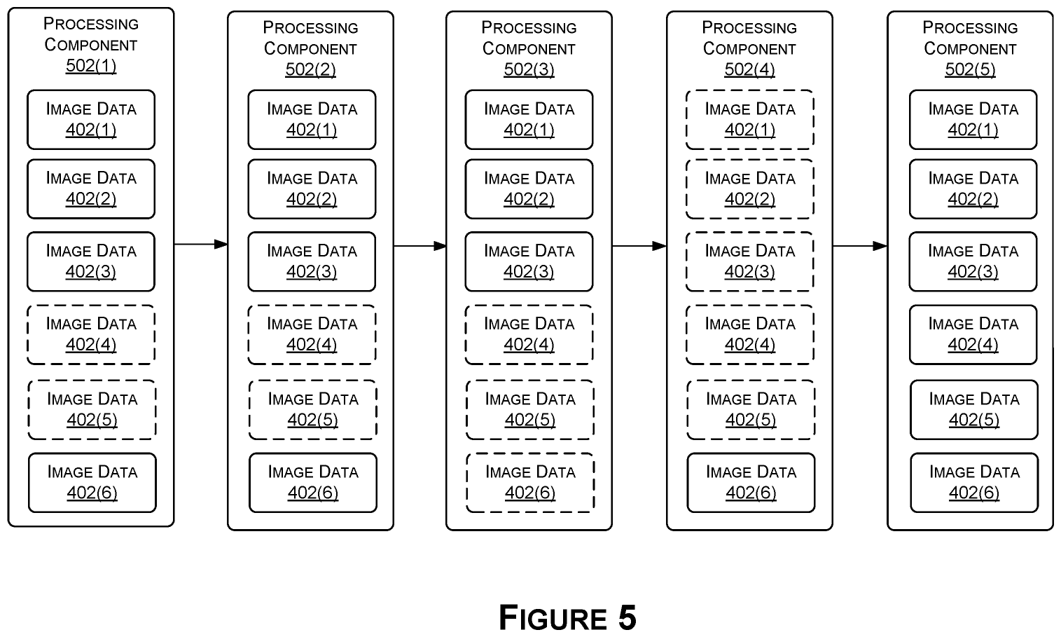

For instance, FIG. 5 illustrates an example scenario in which the frames 302 are processed using different processing components 502(1)-(5) (which may be referred to singularly as “processing component 502” or in plural as “processing components 502”) based at least on the rankings 404 associated with the frames, in accordance with some embodiments of the present disclosure. In some examples, the processing components 502 (which may represent, and/or be similar to, the processing component(s) 128) may be part of an image processing pipeline and perform various image processing tasks associated with the image data 402 representing the frames 302. For example, the processing components 502 may including one or more inferencing components, one or more detection components, one or more segmentation components, one or more tracking components, one or more video composition components, one or more messaging components, and/or any other type of image processing component.

As shown, based at least on the rankings 404(1)-(6), the image data 402(1)-(3) and 402(6) may be processed using the processing components 502(1)-(2) without processing the image data 402(4)-(5) (which is indicated by the dashed lines). In some examples, the image data 402(1)-(3) and 402(6) may be processed using the processing components 502(1)-(2) since the respective frames 302(1)-(3) and 302(6) are associated with the rankings 404(1)-(3) and 404(6) that indicate at least that the frames 302(1)-(3) and 302(6) depict objects 306(1)-(3) and/or motion. For instance, the processing components 502(1)-(2) may be associated with performing inferencing and/or object detection. Additionally, based at least on the rankings 404(1)-(6), the image data 402(1)-(3) may be processed using the processing component 502(3) without processing the image data 402(4)-(6) (which is indicated by the dashed lines). In some examples, the image data 402(1)-(3) may be processed using the processing component 502(3) since the respective frames 302(1)-(3) are associated with the rankings 404(1)-(3) that indicate at least that the frames 302(1)-(3) depict motion of a single object 306(1) and/or a slow moving object 306(1). For instance, the processing component 502(3) may be associated with performing object tracking.

Furthermore, based at least on the rankings 404(1)-(6), the image data 402(6) may be processed using the processing component 502(4) without processing the image data 402(1)-(5) (which is indicated by the dashed lines). In some examples, the image data 402(6) may be processed using the processing component 502(4) since the frame 302(6) is associated with the ranking 404(6) that indicates at least that the frame 302(6) depicts motion of multiple objects 306(2)-(3) and/or fast moving objects 306(2)-(3). For instance, the processing component 502(4) may also be associated with performing object tracking, however, the processing component 502(4) may include a higher quality tracker as compared to the processing component 502(3). Moreover, based at least on the rankings 404(1)-(6), the image data 402(1)-(6) may be processed using the processing component 502(6).

Referring back to the example of FIG. 1, the process 100 may include generating output data 132 associated with the processing of the sensor data 104. For example, if the processing component(s) 128 is associated with performing image processing, then the output data 132 may indicate locations of objects (e.g., bounding shapes) within sensor representations of the sensor data 104, types of the objects, tracking information associated with the objects, and/or any other information associated with the objects. In some examples, the system(s) 112 may then perform one or more operations with respect to the output data 132, such as storing the output data 132 and/or sending the output data 132 to one or more computing devices. Additionally, in some examples, the system(s) 112 may then perform additional processing with respect to the sensor data 104, such as again encoding the sensor data 104 using one or more encoders and/or sending the sensor data 104 (e.g., as again encoded) to one or more other computing devices.

While the example of FIG. 1 illustrates the device(s) 102 as determining the ranking for the sensor data 104 using the configuration data 108, the detection component(s) 110, and/or the ranking component 114, in other examples, the system(s) 112 may determine the ranking using the configuration data 108, the detection component(s) 110, and/or the ranking component 114. For instance, the system(s) 112 may receive the sensor data 104 (and/or the encoded sensor data 120) from the device(s) 102 and then perform similar processes as the device(s) 102 to rank the sensor data 104. Additionally, while the examples herein describe the detection component(s) 110 as performing some of the same types of processing as the processing component(s) 128, in some examples, the detection component(s) 110 may use less computing resources as compared to the processing component(s) 128. For example, the processing component(s) 128 may include higher quality machine learning models, neural networks, algorithms, modules, software, hardware, and/or the like as compared to the detection component(s) 110.

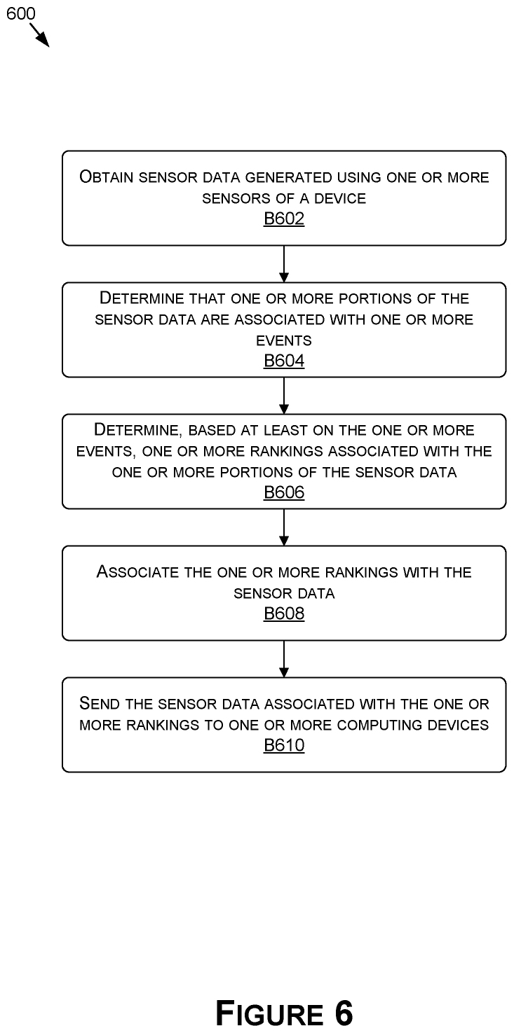

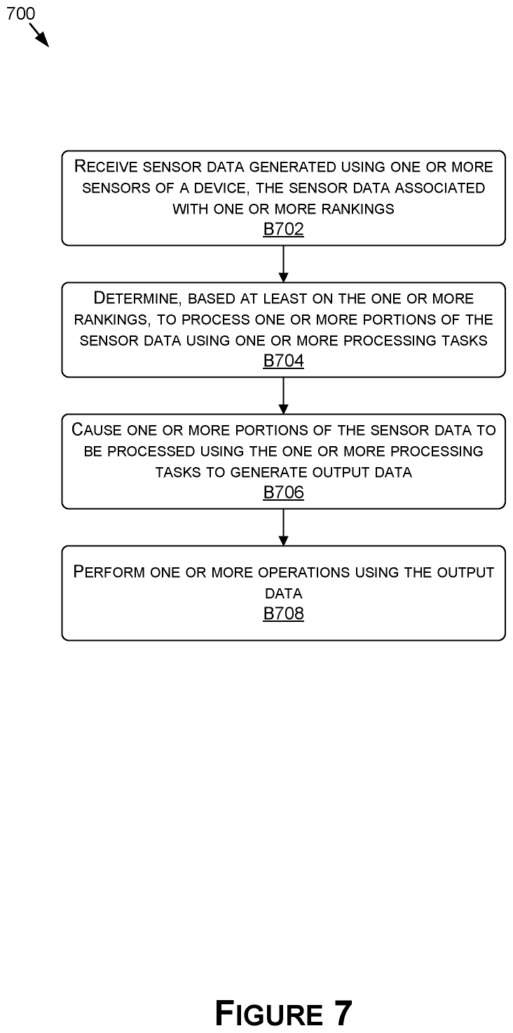

Now referring to FIGS. 6 and 7, each block of methods 600 and 700, described herein, comprises a computing process that may be performed using any combination of hardware, firmware, and/or software. For instance, various functions may be carried out by a processor executing instructions stored in memory. The methods 600 and 700 may also be embodied as computer-usable instructions stored on computer storage media. The methods 600 and 700 may be provided by a standalone application, a service or hosted service (standalone or in combination with another hosted service), or a plug-in to another product, to name a few. In addition, the methods 600 and 700 are described, by way of example, with respect to FIG. 1. However, these methods 600 and 700 may additionally or alternatively be executed by any one system, or any combination of systems, including, but not limited to, those described herein.

FIG. 6 is a flow diagram showing a method 600 for ranking sensor data, in accordance with some embodiments of the present disclosure. The method 600, at block B602, may include obtaining sensor data generated using one or more sensors of a machine. For instance, the device 102 may obtain the sensor data 104 generated using the sensor(s) 106. In some examples, the sensor data 104 may include image data representing one or more frames. In some examples, the device 102 may further receive additional sensor data 104 generated using one or more additional sensors 106, such as LiDAR data, RADAR data, motion data, audio data, and/or any other type of sensor data. In such examples, the additional sensor data 104 may be generated at approximately a same time as the sensor data 104.

The method 600, at block B604, may include determining that one or more portions of the sensor data are associated with one or more events. For instance, the device 102 (e.g., the detection component(s) 110) may determine that the portion(s) of the sensor data 104 is associated with the event(s). In some examples, the device 102 may make the determination based at least on processing the sensor data 104. For instance, the device 102 may determine that the portion(s) of the sensor data 104 represents an object, motion of an object, an amount of light, sound, speech, and/or any other type of event. Additionally, or alternatively, in some examples, the device 102 may make the determination based at least on processing the additional sensor data 104. For instance, the device may determine that the additional sensor data 104 represent an object, motion of an object, an amount of light, sound, speech, and/or any other type of event.

The method 600, at block B606, may include determining, based at least on the one or more events, one or more rankings associated with the one or more portions of the sensor data. For instance, the device 102 (e.g., the ranking component 114) may determine the ranking(s) for the portion(s) of the sensor data 104 based at least on the event(s). As described herein, in some examples, the ranking component 114 may use the configuration data 108 to determine the ranking(s), where the configuration data 108 may associate various types of events with different rankings. For instance, the device 102 may use the configuration data 108 to determine that the event(s) associated with the portion(s) of the sensor data 104 is further associated with the ranking(s). In some examples, the device 102 may determine more than one ranking associated with the portion(s) of the sensor data 104.

The method 600, at block B608, may include associating the one or more rankings with the one or more portions of the sensor data. For instance, the device 102 (e.g., the ranking component 114 and/or the encoding component 118) may associate the ranking(s) with the portion(s) of the sensor data 104. In some examples, to perform the association, the device 102 may generate data representative of the ranking(s) and then associate the data with the sensor data 104. In some examples, to perform the association, the device 102 may embed the ranking(s) into the portion(s) of the sensor data 104. In either example, a portion of the sensor data 104 may include one or more sensor representations (e.g., one or more frames) of the sensor data 104.

The method 600, at block B610, may include sending the sensor data associated with the one or more rankings to one or more computing devices. For instance, the device 102 may send the sensor data 104 that is associated with the ranking(s) to the system(s) 112. In some examples, before sending the sensor data 104, the device 102 (e.g., the encoding component 118) may initially encode the sensor data 104 in order to generate encoded sensor data 120. The device 102 may then send the encoded sensor data 120 to the system(s) 112.

FIG. 7 is a flow diagram depicting a method 700 for using one or more ranking associated with sensor data in order to process the sensor data, in accordance with some embodiments of the present disclosure. The method 700, at block B702, may include receiving sensor data generated using one or more sensors of a device, the sensor data associated with one or more rankings. For instance, the system(s) 112 may receive the sensor data 104 from the device 102. As described herein, in some examples, the system(s) 112 may receive the sensor data 104 as encoded sensor data 120. Additionally, in some examples, the ranking(s) may be embedded within the portion(s) of the sensor data 104. For example, the ranking(s) may be embedded using one or more messages and/or one or more dedicated fields associated with the portion(s) of the sensor data 104.

The method 700, at block B704, may include determining, based at least on the one or more rankings, to process one or more portions of the sensor data to perform one or more processing tasks. For instance, the system(s) 112 (e.g., the determination component 126) may determine one or more of the processing component(s) 128 to use to process the portion(s) of the sensor data 104 based at least on the ranking(s). In some examples, the system(s) 112 may determine the processing component(s) 128 using configuration data 130. For instance, the configuration data 130 may indicate which of the processing component(s) 128 to use to process the portion(s) of the sensor data 104 based at least on the ranking(s) associated with the portion(s) of the sensor data 104. In some examples, the system(s) 112 may further determine one or more of the processing component(s) 128 that should not be used to process the portion(s) of the sensor data 104 based at least on the ranking(s).

The method 700, at block B706, may include causing the one or more portions of the sensor data to be processed using the one or more processing tasks to generate output data and the method 700, at block B708, may include performing one or more operations using the output data. For instance, the system(s) 112 may cause the processing component(s) 128 to process the portion(s) of the sensor data 104 in order to generate the output data 132. As described herein, the system(s) 112 may process the portion(s) of the sensor data 104 using the processing component(s) 128 as part of a processing pipeline (e.g., in an order). The system(s) 112 may then perform one or more operations using the output data 132, such as sending the output data 132 to one or more other devices.

### Example Content Streaming System

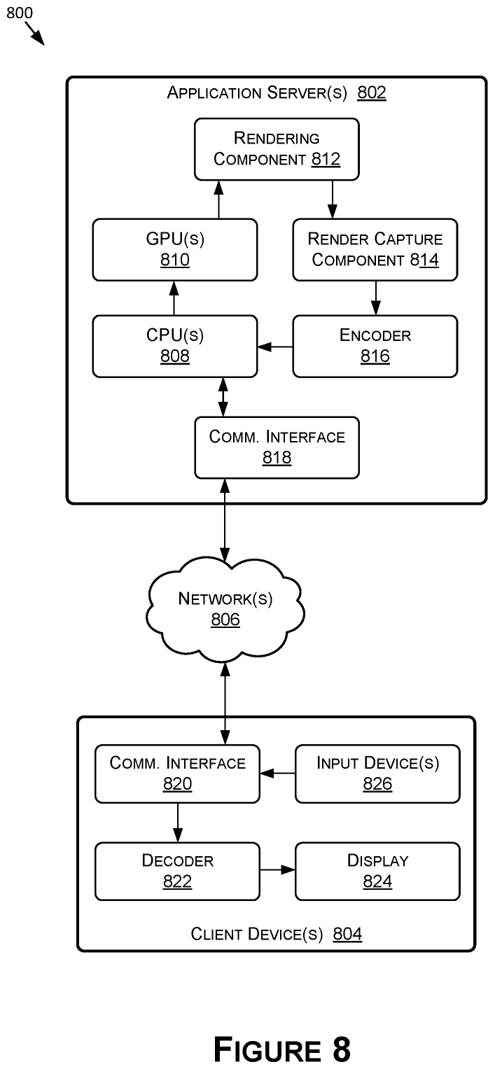

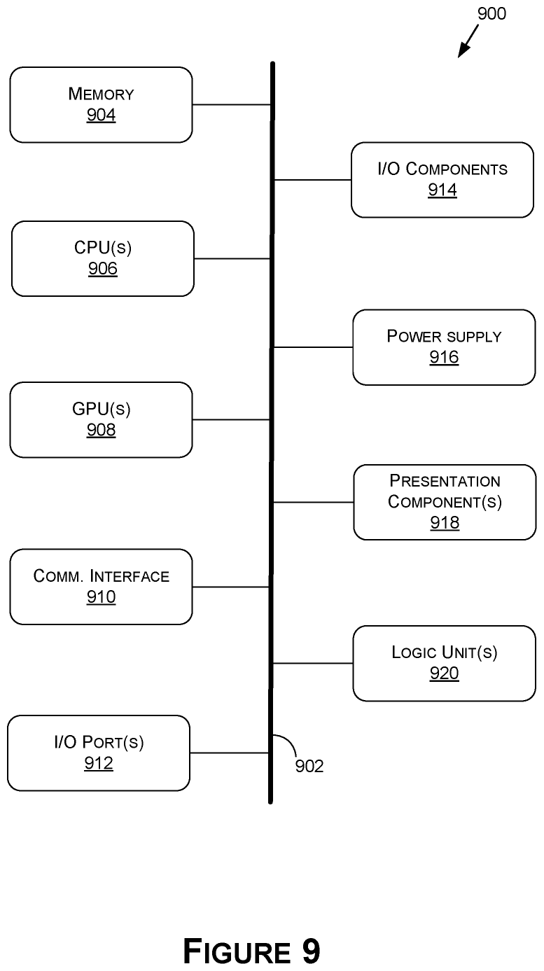

Now referring to FIG. 8, FIG. 8 is an example system diagram for a content streaming system 800, in accordance with some embodiments of the present disclosure. FIG. 8 includes application server(s) 802 (which may include similar components, features, and/or functionality to the example computing device 900 of FIG. 9 and/or which may include the system(s) 112), client device(s) 804 (which may include similar components, features, and/or functionality to the example computing device 900 of FIG. 9 and/or which may include a device 102), and network(s) 806 (which may be similar to the network(s) described herein). In some embodiments of the present disclosure, the system 800 may be implemented. The application session may correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 800, for an application session, the client device(s) 804 may only receive input data in response to inputs to the input device(s), transmit the input data to the application server(s) 802, receive encoded display data from the application server(s) 802, and display the display data on the display 824. As such, the more computationally intense computing and processing is offloaded to the application server(s) 802 (e.g., rendering—in particular ray or path tracing—for graphical output of the application session is executed by the GPU(s) of the game server(s) 802). In other words, the application session is streamed to the client device(s) 804 from the application server(s) 802, thereby reducing the requirements of the client device(s) 804 for graphics processing and rendering.

For example, with respect to an instantiation of an application session, a client device 804 may be displaying a frame of the application session on the display 824 based on receiving the display data from the application server(s) 802. The client device 804 may receive an input to one of the input device(s) and generate input data in response. The client device 804 may transmit the input data to the application server(s) 802 via the communication interface 820 and over the network(s) 806 (e.g., the Internet), and the application server(s) 802 may receive the input data via the communication interface 818. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 812 may render the application session (e.g., representative of the result of the input data) and the render capture component 814 may capture the rendering of the application session as display data (e.g., as image data capturing the rendered frame of the application session). The rendering of the application session may include ray or path-traced lighting and/or shadow effects, computed using one or more parallel processing units-such as GPUs, which may further employ the use of one or more dedicated hardware accelerators or processing cores to perform ray or path-tracing techniques—of the application server(s) 802. In some embodiments, one or more virtual machines (VMs)—e.g., including one or more virtual components, such as vGPUs, vCPUs, etc.—may be used by the application server(s) 802 to support the application sessions. The encoder 816 may then encode the display data to generate encoded display data and the encoded display data may be transmitted to the client device 804 over the network(s) 806 via the communication interface 818. The client device 804 may receive the encoded display data via the communication interface 820 and the decoder 822 may decode the encoded display data to generate the display data. The client device 804 may then display the display data via the display 824.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Computing Device

FIG. 9 is a block diagram of an example computing device(s) 900 (which may include, and/or represent, a device 102 and/or the system(s) 112) suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

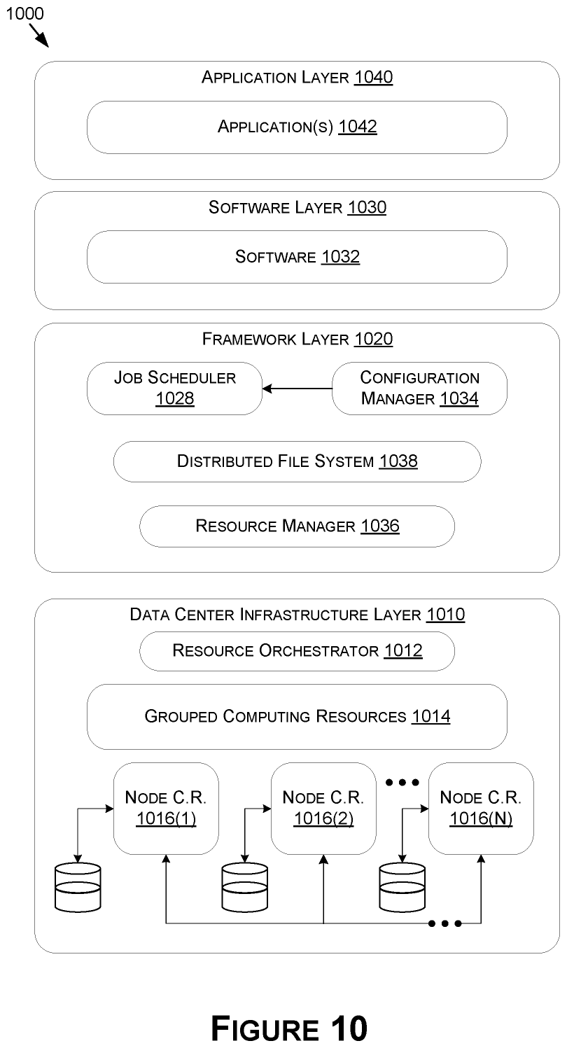

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A device comprising: one or more processors to: obtain image data generated using one or more image sensors, the image data representative of one or more frames; determine that the image data is associated with an occurrence of an event; determine, based at least on the event, a ranking associated with the image data; and send, to one or more computing devices, the image data along with an indication of the ranking.

B: The device of paragraph A, wherein the determination that the image data is associated with the event comprises: analyzing the image data; and determining, based at least on the analyzing, that the one or more frames depict at least a portion of the occurrence of the event.

C: The device of paragraph A or paragraph B, further comprising one or more sensors, and wherein the one or more processors are further to: obtain sensor data generated using the one or more sensors; and detect, based at least on the sensor data, the occurrence of the event during a period of time corresponding to at least a subset of the sensor data, wherein the image data is determined to be associated with the event is based at least on a detection of the occurrence of the event during a period of time corresponding to at least a subset of the sensor data.

D: The device of any one of paragraphs A-C, wherein the one or more processors are further to: obtain information that associates one or more events with one or more rankings, wherein the determination that the ranking is associated with the image data comprises: identifying, based at least on the information, the event from the one or more events; and determining, based at least on the information, that the event is associated with the ranking from the one or more rankings.

E: The device of any one of paragraphs A-D, wherein the event comprises one or more of: a depiction of at least a portion of an object in the one or more frames; a depiction of at least a portion of an object corresponding to an object type in the one or more frames; the one or more frames being associated with motion of the object; the one or more frames being associated with a velocity of the motion; a depiction of at least a portion of a number of objects above a threshold number in the one or more frames; a depiction of an amount of light above a threshold amount in the one or more frames; or the one or more frames being associated with sound detected using audio data.

F: The device of any one of paragraphs A-E, wherein the one or more processors are further to: obtain second image data generated using the one or more image sensors, the second image data representative of one or more second frames; determine that the second image data is associated with a second event; determine, based at least on the second event, a second ranking associated with the second image data that is different than the ranking associated with the image data; and send, to the one or more computing devices, second encoded data corresponding to the second image data and the second ranking.

G: The device of paragraph F, wherein: the image data represents a first plurality of frames that includes the one or more frames; the ranking is associated with the first plurality of frames; the second image data represents a second plurality of frames that includes the one or more second frames; and the second ranking is associated with the second plurality of frames.

H: The device of any one of paragraphs A-G, wherein the one or more processors are further to: process the image data using one or more encoders to generate encoded image data; and embed the ranking associated with the image data into at least one of a message associated with the encoded image data or a field associated with a bitstream of the encoded image data, wherein the encoded image data and the embedded ranking is sent to the one or more computing devices.

I: The device of any one of paragraphs A-H, wherein the ranking causes the one or more computing device to at least one of: perform one or more first image processing tasks using the image data; or refrain from performing one or more second image processing tasks using the image data.

J: The device of any one of paragraphs A-I, wherein the device is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

K: A method comprising: obtaining sensor data generated using one or more sensors; determining that the sensor data is associated with an occurrence of an event; determining, based at least on the event, a ranking associated with the sensor data; and sending, to one or more computing devices, the sensor data and an indication of the ranking.

L: The method of paragraph K, wherein the determining that the sensor data is associated with the event comprises: analyzing the sensor data; and determining, based at least on the analyzing, that the sensor data corresponds to the occurrence of the event.

M: The method of paragraph K or paragraph L, further comprising: obtaining second sensor data generated using the one or more second sensors; and detecting the occurrence of the event based at least on the second sensor data, wherein the determining that the sensor data is associated with the event is based at least on detecting the occurrence of the event based at least on the second sensor data.

N: The method of any one of paragraphs K-M, further comprising: obtaining information that associates one or more events with one or more rankings, wherein the determining the ranking is associated with the sensor data comprises: identifying, based at least on the information, the event from the one or more events; and determining, based at least on the information, that the event is associated with the ranking from the one or more rankings.

O: The method of any one of paragraphs K-N, further comprising: obtaining second sensor data generated using the one or more sensors, the second sensor data representative of one or more second sensor representations; determining that the second sensor data is associated with a second event; determining, based at least on the second event, a second ranking associated with the second sensor data that is different than the ranking associated with the sensor data; and sending, to the one or more computing devices, the second sensor data along with a second indication of the second ranking.

P: The method of paragraph O, wherein: the sensor data represents a first plurality of sensor representations; the ranking is associated with the first plurality of sensor representations; the second sensor data represents a second plurality of sensor representations; and the second ranking is associated with the second plurality of sensor representations.

Q: The method of any one of paragraphs K-P, further comprising: processing the sensor data using one or more encoders to generate encoded sensor data; and embedding the ranking into at least one of a message associated with the encoded sensor data or a field associated with a bitstream corresponding to the encoded sensor data, wherein the sending the sensor data and the data representative of the ranking comprises sending, to the one or more computing devices, the encoded sensor data with the embedded ranking.

R: The method of any one of paragraphs K-Q, wherein the ranking causes the one or more computing device to at least one of: perform one or more first sensor processing tasks using the sensor data; or refrain from performing one or more second sensor processing tasks using the sensor data.

S: One or more processors comprising: one or more processing units to send, to one or more computing devices, image data embedded with a ranking associated with one or more frames represented by the image data, wherein the ranking is determined based at least on determining that the one or more frames is associated with an occurrence of an event corresponding to the ranking.

T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A device comprising:
one or more processors to:
obtain image data generated using one or more image sensors, the image data representative of one or more frames;
determine that the image data is associated with an occurrence of an event;
determine, based at least on the event, a ranking associated with the image data; and
send, to one or more computing devices, the image data along with an indication of the ranking.

2. The device of claim 1, wherein the determination that the image data is associated with the event comprises:
analyzing the image data; and
determining, based at least on the analyzing, that the one or more frames depict at least a portion of the occurrence of the event.

3. The device of claim 1, further comprising one or more sensors, and wherein the one or more processors are further to:
obtain sensor data generated using the one or more sensors; and
detect, based at least on the sensor data, the occurrence of the event during a period of time corresponding to at least a subset of the sensor data,
wherein the image data is determined to be associated with the event is based at least on a detection of the occurrence of the event during a period of time corresponding to at least a subset of the sensor data.

4. The device of claim 1, wherein the one or more processors are further to:
obtain information that associates one or more events with one or more rankings,
wherein the determination that the ranking is associated with the image data comprises:
identifying, based at least on the information, the event from the one or more events; and
determining, based at least on the information, that the event is associated with the ranking from the one or more rankings.

5. The device of claim 1, wherein the event comprises one or more of:
a depiction of at least a portion of an object in the one or more frames;
a depiction of at least a portion of an object corresponding to an object type in the one or more frames;
the one or more frames being associated with motion of the object;
the one or more frames being associated with a velocity of the motion;
a depiction of at least a portion of a number of objects above a threshold number in the one or more frames;
a depiction of an amount of light above a threshold amount in the one or more frames; or
the one or more frames being associated with sound detected using audio data.

6. The device of claim 1, wherein the one or more processors are further to:
obtain second image data generated using the one or more image sensors, the second image data representative of one or more second frames;
determine that the second image data is associated with a second event;
determine, based at least on the second event, a second ranking associated with the second image data that is different than the ranking associated with the image data; and
send, to the one or more computing devices, second encoded data corresponding to the second image data and the second ranking.

7. The device of claim 6, wherein:
the image data represents a first plurality of frames that includes the one or more frames;
the ranking is associated with the first plurality of frames;
the second image data represents a second plurality of frames that includes the one or more second frames; and
the second ranking is associated with the second plurality of frames.

8. The device of claim 1, wherein the one or more processors are further to:
process the image data using one or more encoders to generate encoded image data; and
embed the ranking associated with the image data into at least one of a message associated with the encoded image data or a field associated with a bitstream of the encoded image data,
wherein the encoded image data and the embedded ranking is sent to the one or more computing devices.

9. The device of claim 1, wherein the ranking causes the one or more computing device to at least one of:
perform one or more first image processing tasks using the image data; or
refrain from performing one or more second image processing tasks using the image data.

10. The device of claim 1, wherein the device is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

11. A method comprising:
obtaining sensor data generated using one or more sensors;
determining that the sensor data is associated with an occurrence of an event;
determining, based at least on the event, a ranking associated with the sensor data; and
sending, to one or more computing devices, the sensor data and an indication of the ranking.

12. The method of claim 11, wherein the determining that the sensor data is associated with the event comprises:
analyzing the sensor data; and
determining, based at least on the analyzing, that the sensor data corresponds to the occurrence of the event.

13. The method of claim 11, further comprising:
obtaining second sensor data generated using the one or more second sensors; and
detecting the occurrence of the event based at least on the second sensor data,
wherein the determining that the sensor data is associated with the event is based at least on detecting the occurrence of the event based at least on the second sensor data.

14. The method of claim 11, further comprising:
obtaining information that associates one or more events with one or more rankings,
wherein the determining the ranking is associated with the sensor data comprises:
identifying, based at least on the information, the event from the one or more events; and
determining, based at least on the information, that the event is associated with the ranking from the one or more rankings.

15. The method of claim 11, further comprising:
obtaining second sensor data generated using the one or more sensors, the second sensor data representative of one or more second sensor representations;
determining that the second sensor data is associated with a second event;
determining, based at least on the second event, a second ranking associated with the second sensor data that is different than the ranking associated with the sensor data; and
sending, to the one or more computing devices, the second sensor data along with a second indication of the second ranking.

16. The method of claim 15, wherein:
the sensor data represents a first plurality of sensor representations;
the ranking is associated with the first plurality of sensor representations;
the second sensor data represents a second plurality of sensor representations; and
the second ranking is associated with the second plurality of sensor representations.

17. The method of claim 11, further comprising:
processing the sensor data using one or more encoders to generate encoded sensor data; and
embedding the ranking into at least one of a message associated with the encoded sensor data or a field associated with a bitstream corresponding to the encoded sensor data,
wherein the sending the sensor data and the data representative of the ranking comprises sending, to the one or more computing devices, the encoded sensor data with the embedded ranking.

18. The method of claim 11, wherein the ranking causes the one or more computing device to at least one of:
perform one or more first sensor processing tasks using the sensor data; or
refrain from performing one or more second sensor processing tasks using the sensor data.

19. One or more processors comprising:
one or more processing units to send, to one or more computing devices, image data embedded with a ranking associated with one or more frames represented by the image data, wherein the ranking is determined based at least on determining that the one or more frames is associated with an occurrence of an event corresponding to the ranking.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
